(19) United States
(12) Patent Application Publication
(10) Pub. No.: US 2019/0227011 A1
(43) Pub. Date: Jul. 25, 2019

(54) METHOD FOR MEASURING STEROL CONTENT BY UTILIZING QUANTITATIVE NUCLEAR MAGNETIC RESONANCE TECHNOLOGY

(71) Applicant: OCEAN UNIVERSITY OF CHINA, Shandong (CN)

(72) Inventors: Hongbing LIU, Shandong (CN); Cong WANG, Shandong (CN); Xiuli ZHANG, Shandong (CN); Peiyu ZHANG, Shandong (CN)

(21) Appl. No.: 16/313,673

(22) PCT Filed: Jun. 23, 2017
(86) PCT No.: PCT/CN2017/089709

§ 371 Date: Dec. 27, 2018

(30) Foreign Application Priority Data
Jun. 28, 2016 (CN) 201610489474.6

(51) Int. Cl. G01N 24/08; G01N 1/38

(52) U.S. Cl. CPC G01N 24/08; G01N 1/38

(57) ABSTRACT

A method for measuring the content of sterol and/or derivatives thereof by utilizing nuclear magnetic resonance technology. A nuclear magnetic resonance internal standard method is used, and a specific quantitative peak of sterol and/or derivatives thereof is selected, to accurately measure the (total) content of the sterol and/or derivatives thereof. The method can accurately measure the content of sterol and/or derivatives thereof in extracts of animals, plants and/or microorganisms, food, medicines or cosmetics.

### TECHNICAL FIELD

The present disclosure provides a method for measuring the content of sterol and/or derivatives thereof by utilizing proton nuclear magnetic resonance spectroscopy.

### BACKGROUND

Sterol and derivatives thereof include natural and synthetic sterol and derivatives thereof. Natural sterol and derivatives thereof include phytosterol and zoosterol as well as derivatives thereof. Among them, phytosterol (plant sterols) is a kind of natural alcohol compound with cyclopentane perhydrophenanthrene (steroid nucleus) as a skeleton, which is one of the components that constitute a cell membrane in plants. This kind of compound has a structure similar to cholesterol, has functions of lowering cholesterol and preventing cardiovascular diseases, and is a safe and effective natural phytochemical. In 1999, the US Food and Drug Administration (FDA) approved the use of “healthy” labels for foods to which phytosterols are added. In 2000, the US FDA passed a health statement on phytosterols, and phytosterol-containing margarines and salad dressings were included in functional foods and were widely used in the prevention of chronic diseases in the population. In 2001, the US National Cholesterol Education Program (ATPIII) recommended that daily supplementation of 2 g of phytosterols in a specific population could lower the levels of plasma cholesterol and low-density lipoprotein cholesterol, thereby reducing the risk of coronary heart diseases. At present, Europe, the United States, Japan etc. have widely used phytosterols as food additives for functional foods such as margarine and cooking oil. In China, phytosterols were approved as new resource foods in 2010.

Since there is no UV characteristic absorption in the molecules of sterols and derivatives thereof, the most common UV-visible spectrophotometry cannot be directly used for the measurement of the content of sterols and derivatives thereof. At present, methods for measuring the sterol content mainly include: (1) ultraviolet-visible spectrophotometry after derivatization, and this method has a cumbersome sample pretreatment step with poor reproducibility and narrow linear range; (2) gas chromatography method (GC). Gas chromatography-mass spectrometry (GC-MS) is usually used. It is necessary to saponify a sample first and then perform TMS esterification derivatization reaction, followed by baseline separation through gas chromatography; after the method of measuring the content of the main monomer compounds is established, the monomer contents are added finally to represent the total content of the effective moiety. This method can only measure the content of several known sterols, and ignores other unknown components with similar structures, so the total content results are not accurate enough. There are also reports on the measurement of sterol content by nuclear magnetic resonance techniques, but the quantitative peaks selected are susceptible to interference from other peaks, and the results are also not accurate enough. It is quite necessary to find an accurate, rapid and simple method for accurate measurement of sterol content.

### SUMMARY

In order to overcome the deficiencies existing in the existing methods for measuring sterol content, the present disclosure provides a method for measuring the content of sterol and derivatives thereof by proton nuclear magnetic resonance spectroscopy, which uses a nuclear magnetic resonance internal standard method and selects a specific quantitative peak for sterol and derivatives thereof to measure the content of sterol and derivatives thereof. This method is rapid, simple and accurate.

For this purpose, in one aspect, a method for measuring the content of sterol and/or derivatives thereof using nuclear magnetic resonance techniques is provided, the method comprising steps of: dissolving a sample containing sterol and/or derivatives thereof in an internal standard solution to prepare a test solution, measuring proton nuclear magnetic resonance spectrum of the test sample, selecting a quantitative peak(s) for the sterol and/or derivatives thereof and a quantitative peak(s) for the internal standard to perform integration, to obtain an integral area A_{f} of the quantitative peak(s) for the sterol and/or derivatives thereof and an integral area Aₛ of the quantitative peak(s) for the internal standard, respectively, obtaining the content of the sterol and/or derivatives thereof from the area A_{f} and the area Aₛ; wherein, the sterol and/or derivatives thereof includes one or more compounds selected from the group consisting of sterol, sterol esters, sterol glycosides, and sterol ethers, characterized in that the quantitative peak(s) for the sterol and/or derivatives thereof is the peak(s) of the proton(s) at position 3 of the sterol and/or derivatives thereof.

Preferably, in one embodiment of the aforesaid method, the content of the sterol and/or derivatives thereof is calculated in accordance with the following formula (1):

$${W}_{f} = {W}_{s} \times \frac{{A}_{f}}{{A}_{s}} \times \frac{{N}_{s}}{{N}_{f}} \times \frac{{M}_{f}}{{M}_{s}} \times {P}_{s}$$

wherein, W_{f} is the mass of the sterol and/or derivatives thereof; Wₛ is the mass of an internal standard; A_{f} is the integral area of the quantitative peak(s) for the sterol and/or derivatives thereof; Aₛ is the integral area of the quantitative peak(s) for the internal standard; N_{f} is the number of hydrogen(s) present in the quantitative peak(s) for the sterol and/or derivatives thereof; Nₛ is the number of hydrogen(s) present in the quantitative peak(s) for the internal standard; M_{f} is the molecular weight of the sterol and/or derivatives thereof; Mₛ is the molecular weight of the internal standard; Pₛ is the purity correction factor of the internal standard.

Preferably, in the aforesaid method, the sterol and/or derivatives thereof is a natural sterol and/or derivatives thereof, or a synthetic sterol and/or derivatives thereof. The natural sterol and/or derivatives thereof is a phytosterol and/or derivatives thereof, a zoosterol and/or derivatives thereof, or a microbial sterol and/or derivatives thereof. Preferably, the sterol and/or derivatives thereof is a phytosterol and/or derivatives thereof.

Preferably, in one embodiment of the aforesaid method, the sterol and/or derivatives includes one or more compounds selected from the group consisting of β-sitosterol, campesterol, stigmasterol, brassicasterol, Δ⁵-oat sterol, Δ⁷-oat sterol, ergosterol, fucosterol, sargasso sterol, 24-hydroperoxy-24-vinyl cholesterol, 24R,28R-epoxy-24-ethylcholesterol, 24S, 28S-epoxy-24-ethylcholesterol, 24-hydroperoxystigmasta-5,24(28)-diene-3β-ol, 24-vinyloxycholest-5,23-diene-3β-ol, stigmasta-3β-hydroxy-5,23,25-triene, cholest-5,22-diene-3β-hydroxy-24-ketone, 24-carbonyl-cholesterol, 24-methylene-cholesterol, 3β, 28ξ-dihydroxy-24-ethyl-5,23(Z)cholestadiene; esters formed from the above compounds with palmitic acid, linoleic acid, linolenic acid, EPA, DHA, succinic acid, nicotinic acid, ferulic acid, chlorogenic acid, phospholipids, and so on; and glycosides formed from the above compounds with glucose, galactose, fucose, rhamnose, arabinose, mannose, glucuronic acid, mannuronic acid, guluronic acid, and so on.

Preferably, in one embodiment of the aforesaid method, the sample containing the sterol and/or derivatives thereof is a sample containing two or more compounds selected from sterol, sterol ester, sterol glycoside, and sterol ether, and the content of the sterol and/or derivatives thereof is a total content of sterol and/or derivatives thereof; preferably, calculation is conduced according to the formula (1) by taking the molecular weight of fucosterol or its corresponding derivatives, or the molecular weight of β-sitosterol or its corresponding derivatives as M_{f} representative the molecular weight of the total sterol and/or derivatives.

Preferably, in one embodiment of the aforesaid method, the internal standard is one or more selected from the group consisting of 1,3,5-trimethylbenzene, hydroquinone, 1,3,5-trioxane, 1,2,4,5-tetrachlorobenzene, 2,3,4,5-tetrachloronitrobenzene, 1,4-dinitrobenzene, terephthalic acid, dimethyl terephthalate, monomethyl terephthalate, benzyl benzoate and maleic anhydride.

Preferably, in one embodiment of the aforesaid method, the internal standard solution is prepared by using a deuterated solvent; preferably, the deuterated solvent is one of or a mixture of two or more of deuterated chloroform, deuterated dimethyl sulfoxide, deuterated methanol, deuterated acetone, deuterated water, deuterated dichloromethane, deuterated acetonitrile, deuterated pyridine, and deuterated acetic acid.

Preferably, in one embodiment of the aforesaid method, the test sample solution has a concentration such that the area of the quantitative peak(s) for the sterol and/or derivatives thereof in the proton NMR spectrum is 0.05 to 15 times the area of the quantitative peak(s) for the internal standard; preferably, the test sample solution has a concentration of 0.1 to 25 mg/ml.

Preferably, in one embodiment of the aforesaid method, the measurement of the proton NMR spectrum is carried out at the following conditions: a pulse angle of 30-90 degrees, a relaxation time longer than or equal to 10 s, and a temperature of 20 to 45° C. The number of scans can be greater than or equal to one. For example, the conditions may be: a pulse angle of 45 degrees, a relaxation time of 15 s, a temperature of 25° C., and a number of scans of 32 times.

On the other hand, the present disclosure further provides use of the aforesaid method for measuring the content of a sterol and/or derivatives thereof in extracts of animals, plants and/or microorganisms; food; medicines; or cosmetics.

The method for measuring the content of sterol and/or derivatives thereof by a quantitative proton NMR spectroscopy provided by the present disclosure selects the peak(s) of the 3-H as the quantitative peak(s) for the sterol and/or derivatives and is capable of accurately measuring the content of the sterol and/or derivatives thereof. By selecting a specific quantitative peak, the present disclosure realizes quantitative analysis of multiple components in a mixture, and particularly realizes measurement of the content of the total sterol compounds.

### DETAILED DESCRIPTION

The following examples are merely illustrative and do not limit the scope of the present invention.

### Example 1: Measurement of the Total Phytosterol Content in Seaweed

(1) Preparation of a Test Sample Solution

750 mg of Sargassum fusiforme crude powder was accurately weighed, 4.8 mL of distilled water was added, to perform infiltration for 15 min at room temperature; 12 mL of methanol and 6 mL of dichloromethane (containing 0.01% BHT) were added and shaken for 2 min; 6 mL of dichloromethane was added and shaken for 30 s; 6 mL of water was added and oscillated for 30 s; after centrifugation at 5000 rpm for 15 min, the supernatant was discarded; 15 g of anhydrous sodium sulfate was added, followed by tabling for 1 h, and then the resultant was filtered and concentrated to obtain a total fat. 1 mL of 1M KOH/80% ethanol was added to the total fat, to undergo saponification for 15 h at room temperature and in the dark; 2 mL of water was added to the reaction solution, and extraction was carried out twice with 2 mL of diethyl ether; the diethyl ether layers were combined and washed with water to be neutral, dried by blowing with N₂, to obtain a diethyl ether extract.

An internal standard solution having a concentration of 1.0 mg/ml was prepared by using 2,3,4,5-tetrachloronitrobenzene as the internal standard and deuterated chloroform as the solvent. 0.4 ml of the internal standard solution was transferred accurately to dissolve the aforesaid dried diethyl ether extract, which was fully dissolved, to obtain the test sample solution.

(2) Conditions for Measuring the Total Phytosterol Content by Proton NMR Spectroscopy

An Agilent DD2 500M NMR spectrometer was used. The test sample solution was sealed in a 5 mm nuclear magnetic tube, and proton NMR spectrum was measured according to the following conditions: a pulse angle of 45 degrees, a relaxation time d1=15 s, the number of scans nt=32, a measuring temperature of 25° C., and a window function lb=0.3 Hz.

The resonance peak of the 3-H at 63.52 (1H, m) was selected as the quantitative peak for the sterol of the test sample. The quantitative peak for the sterol was completely separated from the quantitative peak for the internal standard(s, δ=7.74) and was not interfered by other peaks, which satisfy the quantitative requirements.

The obtained protonspectrum was integrated, and the sterol content in the sample was obtained according to formula (1).

$${W}_{f} = {W}_{s} \times \frac{{A}_{f}}{{A}_{s}} \times \frac{{N}_{s}}{{N}_{f}} \times \frac{{M}_{f}}{{M}_{s}} \times {P}_{s} \qquad ( 1 )$$

wherein, W_{f} is the mass of the sterol in the test sample; Wₛ is the mass of the internal standard; Aₛ is the integral area of the quantitative peak for the internal standard; A_{f} is the integral area of the quantitative peak for the sterol in the test sample; N_{f} is the number of hydrogen (which is 1) present in the quantitative peak for the sterol in the test sample; Nₛ is the number of hydrogen (which is 1) present in the quantitative peak for the internal standard; M_{f} is the molecular weight of the sterol in the test sample; Mₛ is the molecular weight (260.9) of the internal standard; Pₛ is the purity correction factor (99.3%) of the internal standard.

(3) Establishment of Methodology for Measuring the Total Phytosterol Content by Proton NMR Spectroscopy

i. Investigation of a Linear Relationship

An internal standard solution having a concentration of 1.0 mg/ml was prepared by using 2,3,4,5-tetrachloronitrobenzene as the internal standard and deuterated chloroform as the solvent. Seven parts of fucosterol standard solutions of different concentrations (0.25, 0.5, 1.0, 2.5, 5.0, 7.5, 10 mg/mL) were prepared by using the internal standard solution as the solvent. 0.4 mL of the above-mentioned fucosterol standard solutions were accurately transferred to a 5 mm nuclear magnetic tube and sealed therein. Proton NMR spectrum was measured according to the above step (2).

Linear regression was performed by using a ratio of the quantitative peak area of fucosterol to the quantitative peak area of the internal standard as the ordinate, and the mass concentration of fucosterol as the abscissa. The regression equation was y=0.6057x+0.0123, and the correlation coefficient r=0.9998. The experimental results show that when the mass concentration of the internal standard is 1.00 mg/mL, the fucosterol has a good linear relationship within the range of 0.25-10.00 mg/mL.

ii. Investigation of Limit of Quantitation and Limit of Detection

According to the proton NMR spectroscopy, the measured concentration at a signal-to-noise ratio S/N=3 is the corresponding limit of detection (LOD), and the measured concentration at a signal-to-noise ratio S/N=10 is the corresponding limit of quantitation (LOQ). Results of experiments carried out using the fucosterol standard solutions showed that the LOD of the method was 31.25 μg/mL and the LOQ was 125.00 μg/mL.

iii. Precision Test

The same test sample solution was subject to proton NMR spectrum measurement according to the above step (2) for six times. According to formula (1), wherein M_{f} is the molecular weight of fucosterol, i.e., 412.7, the RSD of the precision was 0.95%, which indicates that this method has good precision.

iv. Repeatability Test

Six parts of the test sample solution were prepared in parallel, and were subject to proton NMR spectrum measurement according to the above step (2). According to formula (1), wherein M_{f} is the molecular weight of fucosterol, i.e., 412.7, the RSD of the repeatability was 2.36%, which indicates that this method has good repeatability.

v. Stability Test

The same test sample solution was subject to proton NMR spectrum measurement according to the above step (2) at 0, 2, 4, 8, 24, 48, 72 hours, respectively. According to formula (1), wherein M_{f} is the molecular weight of fucosterol, i.e., 412.7, the RSD of the results measured at the respective time points was 0.95%, which indicates that the test solution is stable within 72 hours, which satisfies the measurement requirements.

vi. Recovery Test

The recovery was measured by a standard addition recovery method. 750 mg of Sargassum fusiforme crude powder was weighed, to which an equal mass of a fucosterol standard was added, to prepare six parts of test sample solution in parallel according to the above step (1), and then proton NMR spectrum measurement was carried out according to the above step (2). According to formula (1), wherein M_{f} is the molecular weight of fucosterol, i.e., 412.7, the average recovery was 99.71%, and RSD was 4.48%, which indicates that this method has a relatively high recovery, namely, good accuracy.

(4) Measurement of the Total Content of Phytosterol in Seaweed Samples

Seaweed samples from different sources were respectively taken and prepared into test sample solutions according to the above step (1), and then proton NMR spectrum measurement was carried out according to the above step (2). Each sample was measured three times. According to formula (1), wherein M_{f} is the molecular weight of fucosterol, which is a representative component in the test sample, i.e., 412.7, the total content of phytosterol in the seaweed samples was obtained. Detailed results are shown in Table 1.

TABLE 1
Total content of phytosterol in seaweed
samples from different sources (n = 3)

| | Serial | | Total content of | |
|---|---|---|---|---|
| Samples | number | Sources | phytosterol (mg/kg) | RSD % |
| Sargassum | HL51 | Rongcheng | 1727.59 +/− 10.96 | 0.63 |
| horneri | HL52 | Wenzhou | 2014.54 +/− 79.00 | 3.92 |
| | HS54 | Changdao | 2226.67 +/− 21.33 | 0.98 |
| Sargassum | PT31 | Fujian | 1273.92 +/− 34.90 | 2.74 |
| pallidum | PT32 | Shandong | 1385.43 +/− 34.71 | 2.51 |
| Sargassum | TS48 | Rongcheng | 1908.00 +/− 17.93 | 1.57 |
| thunbergii | TS49 | Changdao | 1981.33 +/− 21/33 | 1.10 |
| Sargassum | FS10 | Hebei | 1881.79 +/− 25.02 | 1.33 |
| fusiforme | FS08 | Jiaonan | 2033.03 +/− 52.35 | 2.58 |
| | FS11 | Weihai | 1916.70 +/− 22.90 | 1.19 |
| | FS01 | Wenzhou | 1829.44 +/− 25.02 | 1.37 |

### Example 2: Measurement of a Total Phytosterol Content in Sargassum fusiforme Extracts

2 g of different batches of Sargassum fusiforme extracts were accurately weighed, to which 1.5 M potassium hydroxide ethanol solution was added respectively according to a material to liquid ratio of 1:10, to undergo reaction at 70° C. for 1.5 h, to obtain a reaction liquid. The reaction liquid was cooled to room temperature, and extracted twice with 1-fold amount of diethyl ether each time. The diethyl ether layers were combined and washed with water to be neutral, dried by blowing with N₂, to obtain a diethyl ether extract. An internal standard solution having a concentration of 1.0 mg/ml was prepared by using 2,3,4,5-tetrachloronitrobenzene as the internal standard and deuterated chloroform as the solvent. 0.4 ml of the internal standard solution was transferred accurately to dissolve the aforesaid dried diethyl ether extract, which was fully dissolved, to obtain the test sample solution.

Proton NMR spectrum measurement was carried out according to step (2) in Example 1, and each sample was measured three times. The obtained proton spectrum was integrated. According to formula (1) in Example 1, wherein M_{f} is the molecular weight of fucosterol, which is a representative component in the test sample, i.e., 412.7, the total content of phytosterol in Sargassum fusiforme extracts was obtained. Detailed results are shown in Table 2.

TABLE 2
Total content of phytosterol in different batches
of Sargassum fusiforme extracts (n = 3)

| Batches of | Total content of | |
|---|---|---|
| extracts | phytosterol (mg/g) | RSD(%) |
| 1 | 14.42 | 2.061 |
| 2 | 11.54 | 1.368 |
| 3 | 12.83 | 2.575 |

### Example 3: Measurement of a Total Phytosterol Content in Maize Oil

200 mg of different batches of maize oil were accurately weighed to prepare test sample solutions in the same way as Example 2.

Proton NMR spectrum measurement was carried out according to step (2) in Example 1. The obtained proton spectrum was integrated. According to formula (1) in Example 1, wherein M_{f} is the molecular weight of β-sitosterol, which is a representative component in the test sample, i.e., 414.7, the total content of phytosterol in maize oil was obtained. Detailed results are shown in Table 3.

TABLE 3
Total content of phytosterol in different
batches of maize oil (n = 3)

| | | Total content of |
|---|---|---|
| Name | Batches | phytosterol (mg/kg) |
| Maize oil | 1 | 6683.89 |
| | 2 | 6804.18 |
| | 3 | 7099.24 |
| | 4 | 6792.70 |
| | 5 | 7005.61 |

### Example 4: Measurement of a Total Phytosterol Content in Health Care Products

20 pieces of health care phytosterol tablets of different brands were finely ground, and 2.00 mg of each sample powder was accurately weighed. An internal standard solution having a concentration of 1.0 mg/ml was prepared by using 2,3,4,5-tetrachloronitrobenzene as the internal standard and deuterated chloroform as the solvent. 0.4 ml of the internal standard solution was transferred accurately to fully dissolve the aforesaid sample powder, which was then subject to centrifugation at 1000 rpm for 5 min, and the supernatant was taken as the test sample solution.

Proton NMR spectrum measurement was carried out according to step (2) in Example 1. The obtained proton spectrum was integrated. According to formula (1) in Example 1, wherein M_{f} is the molecular weight of β-sitosterol, which is a representative component in the test sample, i.e., 414.7, the total content of phytosterol in the phytosterol tablets was obtained. Detailed results are shown in Table 4.

TABLE 4
Total content of phytosterol in different
brands of phytosterol tablets

| | | Phytosterol |
|---|---|---|
| Name | Brand | content (%) |
| Phytosterol tablet | Germany Doppel herz | 78.10 |
| | U.S. GNC | 63.57 |

### Example 5 Method of Measuring the Total Content of Phytosterol in Health Care Products by Proton NMR Spectroscopy

20 pieces of health care phytosterol tablets of different brands were finely ground, and 2.00 mg of each sample powder was accurately weighed. An internal standard solution having a concentration of 1.0 mg/ml was prepared by using 2,3,4,5-tetrachloronitrobenzene as the internal standard and deuterated acetone as the solvent. 0.4 ml of the internal standard solution was transferred accurately to fully dissolve the aforesaid sample powder, which was then subject to centrifugation at 1000 rpm for 5 min, and the supernatant was taken as the test sample solution.

Proton NMR spectrum measurement was carried out according to step (2) in Example 1. A peak of the 3-H at 63.38 (1H, m) was selected as the quantitative peak for the sterol of the test sample. The sterol quantitative peak was completely separated from the internal standard quantitative peak (s, δ=8.21) and was not interfered by other peaks, which satisfy the quantitative requirements. According to formula (1) in Example 1, wherein M_{f} is the molecular weight of β-sitosterol, which is a representative component in the test sample, i.e., 414.7, the total content of phytosterol in the phytosterol tablets was obtained. Detailed results are shown in Table 5.

TABLE 5
Total content of phytosterol in different
brands of phytosterol tablets

| | | Phytosterol |
|---|---|---|
| Name | Brand | content (%) |
| Phytosterol tablet | Germany Doppel herz | 78.00 |
| | U.S. GNC | 63.58 |

### Example 6 Measurement of the Total Content of Phytosterol in Health Care Products

20 pieces of health care phytosterol tablets of different brands were finely ground, and 2.00 mg of each sample powder was accurately weighed. An internal standard solution having a concentration of 1.0 mg/ml was prepared by using dimethyl terephthalate as the internal standard and deuterated chloroform as the solvent. 0.4 ml of the internal standard solution was transferred accurately to fully dissolve the aforesaid sample powder, which was then subject to centrifugation at 1000 rpm for 5 min, and the supernatant was taken as the test sample solution.

Proton NMR spectrum measurement was carried out according to step (2) in Example 1. A resonance peak of the 3-H at 63.52 (1H, m) was selected as the quantitative peak for the sterol of the test sample. The sterol quantitative peak was completely separated from the internal standard quantitative peak (s, δ=8.10) and was not interfered by other peaks, which satisfy the quantitative requirements. According to formula (1), wherein M_{f} is the molecular weight of β-sitosterol, which is a representative component in the test sample, i.e., 414.7, Nₛ is the number of hydrogen (herein is 4) contained in the internal standard quantitative peak, Mₛ is the molecular weight (194.2) of the internal standard, Pₛ is the purity correction factor (99.9%) of the internal standard, the total content of phytosterol in the phytosterol tablets was obtained. Detailed results are shown in Table 6.

TABLE 6
Total content of phytosterol in different
brands of phytosterol tablets

| | | Phytosterol |
|---|---|---|
| Name | Brand | content (%) |
| Phytosterol tablet | Germany Doppel herz | 78.20 |
| | U.S. GNC | 63.59 |

### Example 7: Method for Measuring the Content of Sterol Ester by H-NMR

An internal standard solution having a concentration of 1.0 mg/ml was prepared by using 2,3,4,5-tetrachloronitrobenzene as the internal standard and deuterated chloroform as the solvent. 2.00 mg of a synthetic sample powder of Sargasso sterol 3-stearate was precisely weighed, to which 0.4 ml of the internal standard solution was added to fully dissolve the powder, to obtain a test sample solution.

Proton NMR spectrum measurement was carried out according to step (2) in Example 1. A resonance peak of 3-H at 64.61 (1H, m) was selected as the quantitative peak for the Sargasso sterol 3-stearate, which was completely separated from the internal standard quantitative peak (s, 6=7.74) and was not interfered by other peaks, which satisfy the quantitative requirements. According to formula (1) in Example 1, wherein M_{f} is the molecular weight of Sargasso sterol 3-stearate, i.e., 695.2, the measured content of Sargasso sterol 3-stearate in the synthetic sample was 98.50%.

### Example 8: Measurement of the Content of Sterol Glycoside

An internal standard solution having a concentration of 1.0 mg/ml was prepared by using 2,3,4,5-tetrachloronitrobenzene as the internal standard and deuterated dimethyl sulfoxide as the solvent. 2.00 mg of laboratory-made sitosterol-3-O-β-glucoside was precisely weighed, to which 0.4 ml of the internal standard solution was accurately added to fully dissolve the powder.

Proton NMR measurement was carried out in conditions according to step (2) in Example 1. A resonance peak of the 3-H at 63.66 (1H, m) was selected as the quantitative peak for the sitosterol-3-O-β-glucoside, which was completely separated from the internal standard quantitative peak (s, 6=8.48) and was not interfered by other peaks, which satisfy the quantitative requirements. According to formula (1) in Example 1, wherein M_{f} is the molecular weight of sitosterol-3-O-β-glucoside, i.e., 576.9, the measured content of sitosterol-3-O-β-glucoside in the test sample was 99.23%.

The method for measuring the content of sterol and/or derivatives thereof by utilizing a quantitative nuclear magnetic resonance technique of the present disclosure has advantages mainly manifested in the following aspects. (1) For sterol samples with multiple sets of peak signal, the present disclosure can accurately measure the content of an individual sterol and the total sterols by selecting a specific peak as the quantitative peak, enabling quantitative analysis of the total sterols and/or derivatives thereof. (2) Identification and detection can be performed simultaneously. The method of the present disclosure can provide information of both structure and content of a substance, and particularly has a unique isomer recognition capability. (3) The experiment consumes less and is non-destructive to the sample, and after the experiment is completed, the sample can be recovered, which is especially suitable for the measurement of unstable compounds and large batch samples. (4) The sample preparation is simple, which does not need chromatographic separation in advance and derivatization. The method has high operability, and is a new, simple, rapid and accurate analysis method.

1. A method for measuring the content of sterol and/or derivatives thereof by nuclear magnetic resonance spectroscopy, the method comprising steps of: dissolving a sample containing sterol and/or derivatives thereof in an internal standard solution to prepare a test sample solution, measuring proton nuclear magnetic resonance spectrum of the test sample solution, selecting a quantitative peak(s) for the sterol and/or derivatives thereof and a quantitative peak(s) for the internal standard to perform integration, to obtain an integral area A_{f} of the quantitative peak(s) for the sterol and/or derivatives thereof and an integral area Aₛ of the quantitative peak(s) for the internal standard, respectively, obtaining the content of the sterol and/or derivatives thereof from the area A_{f} and the area Aₛ; wherein, the sterol and/or derivatives thereof is one or more compounds selected from the group consisting of sterol, sterol esters, sterol glycosides, and sterol ethers, characterized in that the quantitative peak(s) for the sterol and/or derivatives thereof is the peak(s) of the proton(s) at position 3 of the sterol and/or derivatives thereof.

2. The method according to claim 1, wherein the content of the sterol and/or derivatives thereof is calculated in accordance with the following formula (1):
$${W}_{f} = {W}_{s} \times \frac{{A}_{f}}{{A}_{s}} \times \frac{{N}_{s}}{{N}_{f}} \times \frac{{M}_{f}}{{M}_{s}} \times {P}_{s} \qquad ( 1 )$$
wherein, W_{f} is the mass of the sterol and/or derivatives thereof; Wₛ is the mass of the internal standard; A_{f} is the integral area of the quantitative peak(s) for the sterol and/or derivatives thereof; Aₛ is the integral area of the quantitative peak(s) for the internal standard; N_{f} is the number of hydrogen(s) present in the quantitative peak(s) for the sterol and/or derivatives thereof; Nₛ is the number of hydrogen(s) present in the quantitative peak(s) for the internal standard; M_{f} is the molecular weight of the sterol and/or derivatives thereof; Mₛ is the molecular weight of the internal standard; Pₛ is the purity correction factor of the internal standard.

3. The method according to claim 1, wherein the sterol and/or derivatives thereof is a natural sterol and/or derivatives thereof, or a synthetic sterol and/or derivatives thereof, wherein the natural sterol and/or derivatives thereof is a phytosterol and/or derivatives thereof, a zoosterol and/or derivatives thereof, or a microbial sterol and/or derivatives thereof.

4. The method according to claim 3, wherein the sterol and/or derivatives includes one or more compounds selected from the group consisting of β-sitosterol, campesterol, stigmasterol, brassicasterol, Δ⁵-oat sterol, Δ⁷-oat sterol, ergosterol, fucosterol, sargasso sterol, 24-hydroperoxy-24-vinyl cholesterol, 24R,28R-epoxy-24-ethylcholesterol, 24S, 28S-epoxy-24-ethylcholesterol, 24-hydroperoxystigmasta-5,24(28)-diene-3β-ol, 24-vinyloxycholest-5,23-diene-3β-ol, stigmasta-3β-hydroxy-5,23,25-triene, cholest-5,22-diene-3β-hydroxy-24-ketone, 24-carbonyl-cholesterol, 24-methylene-cholesterol, 3β, 28ξ-dihydroxy-24-ethyl-5,23(Z)cholestadiene; esters formed from the above compounds with palmitic acid, linoleic acid, linolenic acid, EPA, DHA, succinic acid, nicotinic acid, ferulic acid, chlorogenic acid, or phospholipids, and so on; and glycosides formed from the above compounds with glucose, galactose, fucose, rhamnose, arabinose, mannose, glucuronic acid, mannuronic acid, or guluronic acid.

5. The method according to claim 1, wherein; the sample containing the sterol and/or derivatives thereof is a sample containing two or more compounds selected from sterol, sterol esters, sterol glycosides, and sterol ethers, and the content of the sterol and/or derivatives thereof is a total content of sterol and/or derivatives thereof.

6. The method according to claim 1, wherein the internal standard is one or more selected from the group consisting of 1,3,5-trimethylbenzene, hydroquinone, 1,3,5-trioxane, 1,2,4,5-tetrachlorobenzene, 2,3,4,5-tetrachloronitrobenzene, 1,4-dinitrobenzene, terephthalic acid, dimethyl terephthalate, monomethyl terephthalate, benzyl benzoate and maleic anhydride.

7. The method according to claim 1, wherein the internal standard solution is prepared by using a deuterated solvent.

8. The method according to claim 1, wherein the test sample solution has a concentration such that the area of the quantitative peak(s) for the sterol and/or derivatives thereof in the proton NMR spectrum is 0.05 to 15 times the area of the quantitative peak(s) for the internal standard.

9. The method according to claim 1, wherein the measurement of the proton NMR spectrum is carried out at the following conditions: a pulse angle of 30 to 90 degrees, a relaxation time longer than or equal to 10 s, and a temperature of 20 to 45° C.

10. Use of the method according to claim 1 for measuring the content of a sterol and/or derivatives thereof in extracts of animals, plants and/or microorganisms; food; medicines; or cosmetics.

11. The method according to claim 3, wherein the sterol and/or derivatives thereof is a phytosterol and/or derivatives thereof.

12. The method according to claim 2, wherein the sterol and/or derivatives includes one or more compounds selected from the group consisting of β-sitosterol, campesterol, stigmasterol, brassicasterol, Δ5-oat sterol, Δ7-oat sterol, ergosterol, fucosterol, sargasso sterol, 24-hydroperoxy-24-vinyl cholesterol, 24R,28R-epoxy-24-ethylcholesterol, 24S, 28S-epoxy-24-ethylcholesterol, 24-hydroperoxystigmasta-5,24(28)-diene-3β-ol, 24-vinyloxycholest-5,23-diene-3β-ol, stigmasta-3β-hydroxy-5,23,25-triene, cholest-5,22-diene-3β-hydroxy-24-ketone, 24-carbonyl-cholesterol, 24-methylene-cholesterol, 3β, 28ξ-dihydroxy-24-ethyl-5,23(Z)cholestadiene; esters formed from the above compounds with palmitic acid, linoleic acid, linolenic acid, EPA, DHA, succinic acid, nicotinic acid, ferulic acid, chlorogenic acid, or phospholipids; and glycosides formed from the above compounds with glucose, galactose, fucose, rhamnose, arabinose, mannose, glucuronic acid, mannuronic acid, or guluronic acid.

13. The method according to claim 2, wherein the sample containing the sterol and/or derivatives thereof is a sample containing two or more compounds selected from sterol, sterol esters, sterol glycosides, and sterol ethers, and the content of the sterol and/or derivatives thereof is a total content of sterol and/or derivatives thereof.

14. The method according to claim 13, wherein calculation is conduced according to the formula (1) by taking the molecular weight of fucosterol or its corresponding derivatives, or the molecular weight of β-sitosterol or its corresponding derivatives as M_{f} representative the molecular weight of the total sterol and/or derivatives.

15. The method according to claim 2, wherein the internal standard is one or more selected from the group consisting of 1,3,5-trimethylbenzene, hydroquinone, 1,3,5-trioxane, 1,2,4,5-tetrachlorobenzene, 2,3,4,5-tetrachloronitrobenzene, 1,4-dinitrobenzene, terephthalic acid, dimethyl terephthalate, monomethyl terephthalate, benzyl benzoate and maleic anhydride.

16. The method according to claim 7, wherein the deuterated solvent is one of or a mixture of two or more of deuterated chloroform, deuterated dimethyl sulfoxide, deuterated methanol, deuterated acetone, deuterated water, deuterated dichloromethane, deuterated acetonitrile, deuterated pyridine, and deuterated acetic acid.

17. The method according to claim 2, wherein the test sample solution has a concentration such that the area of the quantitative peak(s) for the sterol and/or derivatives thereof in the proton NMR spectrum is 0.05 to 15 times the area of the quantitative peak(s) for the internal standard.

18. The method according to claim 8, wherein the test sample solution has a concentration of 0.1 to 25 mg/ml.

19. The method according to claim 15, wherein the test sample solution has a concentration of 0.1 to 25 mg/ml.
